(19) United States
(12) Patent Application Publication
(10) Pub. No.: US 2010/0223995 A1
(43) Pub. Date: Sep. 9, 2010

(54) Sensor apparatus and sensor apparatus attachment structure

(75) Inventor: Tatsuya Watanabe, Anjo-city (JP)

Correspondence Address: HARNESS, DICKEY & PIERCE, P.L.C., P.O. BOX 828, BLOOMFIELD HILLS, MI, 48303, US

(73) Assignee: DENSO CORPORATION, Kariya-city (JP)

(21) Appl. No.: 12/660,718

(22) Filed: Mar. 3, 2010

(30) Foreign Application Priority Data
Mar. 6, 2009 (JP) 2009-053303

(51) Int. Cl. G01D 11/24; G01D 21/00

(52) U.S. Cl. 73/431; 73/866.5

(57) ABSTRACT

A sensor apparatus is disclosed, which includes: a terminal; an electronic component that is connected with a first end part of the terminal; an insulating resin that seals the electronic component and the terminal, with a second end part of the terminal being exposed from the insulating resin; a case resin that is mixed with a conductive filler, and seals the insulating resin so that a first portion of the second end part is exposed from the case resin and a second portion of the second end part is covered by the case resin; and a coating material that is formed on the second portion of the second end part to electrically insulate the terminal from the case resin.

### CROSS REFERENCE TO RELATED APPLICATION

The present application is based on Japanese Patent Application No. 2009-53303 filed on Mar. 6, 2009, disclosure of which is incorporated herein by reference.

### BACKGROUND OF THE INVENTION

1. Field of the Invention

The present invention relates to a sensor apparatus for detecting a physical quantity, and also relates to a structure for attaching a sensor apparatus to a target object.

2. Description of Related Art

A sensor apparatus without having a printed circuit board has been proposed in, for example, JP-2008-241456A corresponding to US-2008/0236307A. Such a sensor apparatus includes: an electronic component; a case for receiving the electronic component; and an external connection terminal hold by the case while a part of the external connection terminal is being protruded from the case. In this sensor apparatus, since the electronic component is received in the case without use of a printed circuit board, the sensor apparatus can be manufactured at low cost.

The inventor of the present application has clarified that the conventional technique involves the following problem. Since the above sensor apparatus is configured not to use a printed circuit board, the sensor apparatus cannot take measures against electromagnetic noise by using a printed circuit board. Thus, there is a problem of lowering a resistance against extrinsic electromagnetic noise.

More specifically, when a sensor apparatus has a printed circuit board, it is possible to take measures against electromagnetic noise by providing a sensor circuit with a protection element or by designing a wiring pattern of a printed circuit board of the sensor circuit. In contrast, when a sensor apparatus is configured without use of printed circuit board to meet the need for manufacturing the sensor apparatus at low cost, it becomes impossible to take measures against electromagnetic noise by using a wiring pattern of a printed circuit board. An alternative way for noise resistance improvement is thus required.

### SUMMARY OF THE INVENTION

In view of the above points, it is an objective of the present invention to provide a sensor apparatus that can improve noise resistance and prevent an occurrence of error in an electromagnetic noise condition even when the sensor apparatus is configured not to have a printed circuit board. It is also an objective of the present invention to provide a structure for attaching such sensor apparatus.

According to a first aspect of embodiments of the present invention, a sensor apparatus is provided. The sensor apparatus includes an electronic component, a terminal, an insulating resin, a case resin and a coating material. The electronic component is configured to detect a physical quantity and output an electric signal based on the detected physical quantity. The terminal has a first end part and a second end part, the first end part being electrically connected with the electronic component. The insulating resin seals the electronic component and the first end part of the terminal so that the second end part of the terminal is exposed from the insulating resin. The case resin is mixed with a conductive filler, and seals the insulating resin so as to surround the insulating resin so that a first portion of the second end part is exposed from the case resin and a second portion of the second end part is covered by the case resin. The coating material is formed on the second portion of the second end part of the terminal to electrically insulate the terminal from the case resin.

According to the sensor apparatus with the first aspect, since the electronic component is surrounded by the case resin mixed with the conductive filler, it is possible to prevent an electromagnetic noise from entering an inside of the case resin. It is thus possible to electromagnetically shield the electronic component from the electromagnetic noise. Therefore, even when the sensor apparatus is configured not to have a printed circuit board, it is possible to prevent an error of the sensor apparatus when the sensor apparatus is placed in an electromagnetic noise condition. It is possible to improve a noise resistance performance of the sensor apparatus.

The above sensor apparatus may be configured such that: the coating material is further formed on a wall surface of the insulating resin; and the case resin seals the coating material so as to surround the coating material, so that the first portion of the second end part of the terminal is exposed from the case resin.

According to the above configuration, since the coating material covers the insulating resin and the second portion of the second end part of the terminal, it is possible to electrically insulate the second portion of the second end part of the terminal from the case resin.

The above sensor apparatus may be configured such that: the case resin has a waterproof connector for external electrical connection; the first portion of the second end part of the terminal is exposed to an inside of the waterproof connector; and the coating material has a part that is exposed to the inside of the waterproof connector from a wall surface of the case resin.

According to the above configuration, because of the waterproof connector of the case resin, the part of the coating material and the first portion of the second end part of the terminal are exposed to the inside of the waterproof connector. Thus, it is possible to prevent water and the like from contacting the part of the coating material and the first portion of the second end part of the terminal. It is therefore possible to improve a waterproof performance in an inside of the case resin.

According to a second aspect of embodiments of the present invention, a sensor apparatus is provided. The sensors apparatus includes: an electronic component that is configured to detect a physical quantity and output an electric signal based on the detected physical quantity; a terminal that has a first end part and a second end part, the first end part being electrically connected with the electronic component; an insulating resin that seals the electronic component and the first end part of the terminal so that the second end part of the terminal is exposed from a predetermined part of the insulating resin; and a case resin that is mixed with a conductive filler, and seals the insulating resin while surrounding the insulating resin so that the predetermined part of the insulating resin is protruded from a wall surface of the case resin, and the second end part of the terminal is exposed from the predetermined part of the insulating resin.

According to the sensor apparatus with the second aspect, since the electronic component is surrounded by the case resin mixed with the conductive filler, it is possible to electromagnetically shield the electronic component from an electromagnetic noise. Moreover, it is possible to prevent the terminal from contacting the case resin, because the insulating resin is sealed by the case resin such that the second end part of the terminal is protruded from the predetermined part of the insulating resin and the predetermined part of the insulating resin is protruded from the wall surface of the case resin. It is therefore possible to prevent an occurrence of electric short between the case resin and the terminal sealed by the insulating resin.

The above sensor apparatus may be configured such that: the case resin has a waterproof connector for external electrical connection; the predetermined part of the insulating resin is protruded from the wall surface of the case resin into the inside of the waterproof connector; and the second end part of the terminal is exposed to the inside of the waterproof connector.

According to the above configuration, since the predetermined part of the insulating resin and the second end part of the terminal are located inside the waterproof connector, the waterproof connector can protect the predetermined part of the insulating resin and the second end part of the terminal. It is therefore improve waterproof performance in the inside of the resin case.

The above sensor apparatus may be configured such that: the terminal is a plurality of terminals, one of which is a GND terminal; and an edge portion of the first end part of the GND terminal is protruded from the insulating resin and is sealed by the case resin, so that the protruded edge portion of the first end part of the GND terminal directly contacts the case resin.

According to the above configuration, since the GND terminal can be connected to an external ground, the conductive filler of the case resin can have a GND electric potential, and an electromagnetic nose can be transferred to the ground. It is therefore possible to enhance an electromagnetic shielding performance of the case resin.

According to a third aspect of embodiments of the present invention, a sensor apparatus is provided. The sensor apparatus includes an electronic component, a terminal, a first insulating resin, a conductive film and a second insulating resin. The electronic component is configured to detect a physical quantity and output an electric signal based on the detected physical quantity. The terminal has a first end part and a second end part, the first end part being electrically connected with the electronic component. The first insulating resin seals the electronic component and the first end part of the terminal so that the second end part of the terminal is exposed from a predetermined part of the first insulating resin. The conductive film is formed on a wall surface of the first insulating resin so as to surround the first insulating resin. The second insulating resin that seals the conductive film so that: the predetermined part of the first insulating resin is protruded from a wall surface of the second insulating resin; and the second end part of the terminal is exposed from the predetermined part of the first insulating resin. The terminal is a plurality of terminals, one of which is a GND terminal directly contacting the conductive film.

According to the above sensor apparatus with the third aspect, since the electronic component is surrounded by the conductive film, it is possible to prevent an electromagnetic noise from entering an inside of the first insulating resin. It is possible to electromagnetically shield the electromagnetic component from the electromagnetic noise. Moreover, since the conductive film can be electrically connected to GND, it is possible to transfer the electromagnetic noise to the GND, and it is possible to enhance an electromagnetic shielding performance. Therefore, even when a sensor apparatus is configured not to have a printed wiring board, it is possible to improve a noise resistance of the sensor apparatus and it is possible to prevent an electromagnetic noise from causing error of the sensor apparatus when the sensor apparatus is placed in electromagnetic noise condition.

According to a fourth aspect of embodiments of the present invention, a sensor apparatus is provided. The sensor apparatus includes: an electronic component that is configured to detect a physical quantity and output an electric signal based on the detected physical quantity; a terminal that has a first end part and a second end part, the first end part being electrically connected with the electronic component; a first insulating resin that seals the electronic component and the first end part of the terminal so that the second end part of the terminal is exposed from a predetermined part of the first insulating resin; a second insulating resin that seals the first insulating resin so that the second end part of the terminal is exposed; and a conductive film that is formed on a wall surface of the second insulating resin so as to surround the second insulating resin, wherein the predetermined part of the first insulating resin is protruded from the second insulating resin.

According to the sensor apparatus with the fourth aspect, since the electronic component is surrounded by the conductive film, it is possible to prevent an electromagnetic noise from entering an inside of the first insulating resin. It is hence possible to electromagnetically shield the electronic component from the electromagnetic noise. Therefore, even if a sensor apparatus is configured not to have a printed wiring board, it is possible to improve a noise resistance of the sensor apparatus and it is possible to prevent an electromagnetic noise from causing error of the sensor apparatus when the sensor apparatus is placed in electromagnetic noise condition.

The sensor apparatus with the third aspect and the fourth aspect may be configured such that; the second insulating resin has a waterproof connector for external electrical connection; the second end part of the terminal is exposed to an inside of the waterproof connector; and the predetermined part of the first insulating resin is protruded from the wall surface of the second insulating resin into the inside of the waterproof connector.

According to the above configuration, since the predetermined part of the first insulating resin and the second end part of the terminal are located inside the waterproof connector, the waterproof connector can protect the predetermined part of the first insulating resin and the second end part of the terminal. It is therefore possible to improve waterproof performance in the inside of the second insulating resin.

According to a fifth aspect of embodiments of the present invention, there is provided a structure for sensor apparatus attachment to a target object. The structure includes: a sensor apparatus according to the above first aspect or the second aspect; and a tubular metal bush that is sealed in the case resin and is configured to fix the sensor apparatus to the target object in such manner that the tubular metal bush is brought into contact with the target object, and a metal bolt is inserted into the tubular metal bush.

According to the above structure with the fifth aspect, since the conductive filler mixed in the case resin is electrically connected with the target object via the metal bush and the metal bolt, it is possible to transfer the electromagnetic noise to the target object. It is therefore possible to enhance the electromagnetic shield performance of the conductive filler.

According to a sixth aspect of embodiments of the present invention, there is provided a structure for sensor apparatus attachment to a target object. The structure includes: a sensor apparatus according to the above third aspect; and a tubular metal bush that is sealed in the second insulating resin and is configured to fix the sensor apparatus to the target object in such manner that the tubular metal bush is brought into contact with the target object, and a metal bolt is inserted into the tubular metal bush.

According to a seventh aspect of embodiments of the present invention, there is provided a structure for sensor apparatus attachment to a target object. The structure includes: a sensor apparatus according to the fourth aspect; and a tubular metal bush that is sealed in the second insulating resin and is configure to fix the sensor apparatus to the target object in such manner that the tubular metal bush is brought into contact with the target object, and a metal bolt is inserted into the tubular metal bush, wherein the conductive film is formed on the wall surface of the second insulating resin so that the tubular metal bush contacts the conductive film.

According to the structure with the sixth aspect and the seventh aspect, since the conductive film is electrically connected with the target object via the metal bush and the metal bolt, it is possible to transfer the electromagnetic noise to the target object. It is therefore possible to enhance the electromagnetic shield performance of the conductive film.

### BRIEF DESCRIPTION OF THE DRAWINGS

The above and other objects, features and advantages of the present invention will become more apparent from the following detailed description made with reference to the accompanying drawings. In the drawings:

FIG. 1 is a diagram illustrating a perspective view of a sensor apparatus according to a first embodiment;

FIG. 2 is a diagram illustrating a cross sectional view of the sensor apparatus taken along line II-II in FIG. 1;

FIG. 3 is a diagram illustrating a cross sectional view of the sensor apparatus attached to a body of a vehicle;

FIG. 4 is a diagram illustrating a cross sectional view of a sensor apparatus according to a second embodiment;

FIG. 5 is a diagram illustrating a cross sectional view of a sensor apparatus according to a third embodiment;

FIG. 6 is a diagram illustrating a cross sectional view of a sensor apparatus according to a fourth embodiment;

FIG. 7 is a diagram illustrating a cross sectional view of a sensor apparatus according to a fifth embodiment; and

FIG. 8 is a diagram illustrating a cross sectional view of a sensor apparatus according to a sixth embodiment.

### DETAILED DESCRIPTION OF THE EXEMPLARY EMBODIMENTS

The exemplary embodiments will be described below with reference to the accompanying drawings. In the below-described embodiments, like reference numerals are used to refer to like parts.

### First Embodiment

A first embodiment is described below with reference to the drawings. A sensor apparatus illustrated in the present embodiment can be used in, for example, a system that detects acceleration or deceleration resulting from a collision between vehicles or between a vehicle and an object, and determines whether a passenger protection apparatus should be activated or not.

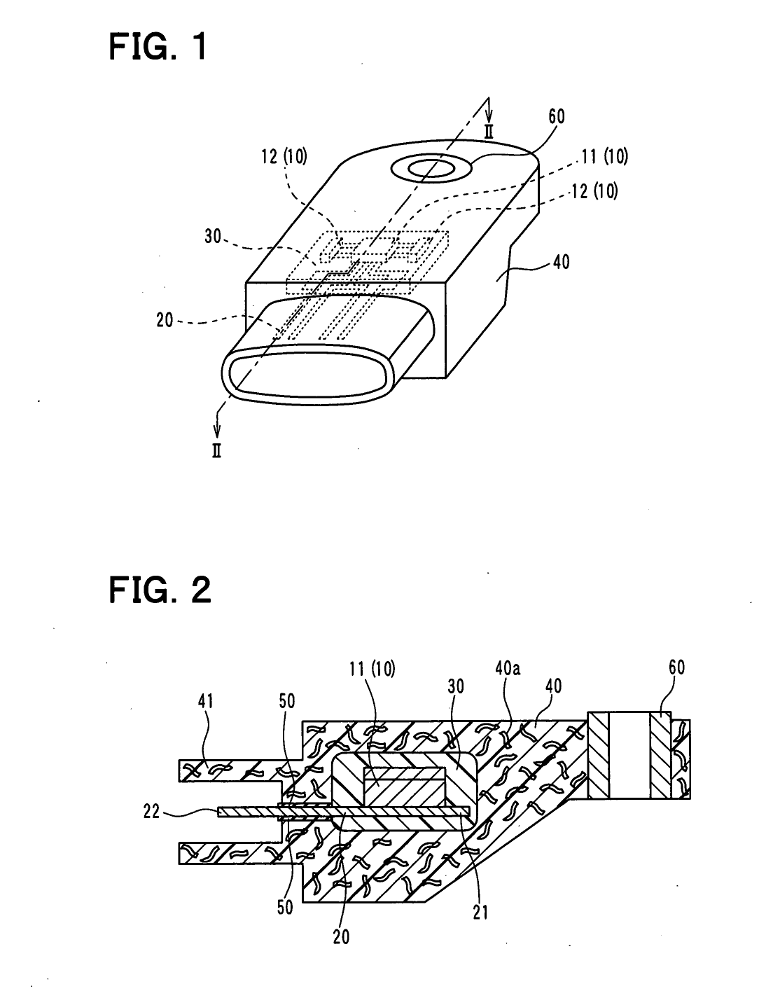

FIG. 1 is a diagram illustrating a perspective view of the sensor apparatus according to the present embodiment. FIG. 2 is a diagram illustrating a cross sectional view of the sensor apparatus taken along line II-II in FIG. 1. As shown in FIGS. 1 and 2, the sensor apparatus includes an electronic component 10, a terminal 20, an insulating resin 30, a case resin 40 and a coating material 50.

The electronic component 10 is configured to be a circuit for detecting a physical quantity and outputting an electric signal indicative of the physical quantity. The electronic component 10 includes a sensor chip 11 and a capacitor 12.

The sensor chip 11 detects a physical quantity such as acceleration and the like, and is formed as, for example, a MEMS (microelectromechanical system) device. For example, the sensor chip 11 has a beam structure formed in a silicon substrate or the like. The beam structure may be a comb or interdigital structure. The sensor chip detects a capacitance between a fixed electrode and a movable electrode, which is changeable in accordance with an applied physical quantity such as acceleration and the like. The capacitor 12 is used for operating the sensor chip 11.

As the sensor chip 11, it is possible to employ a sensor chip configured to detect acceleration, angular velocity or the like. Alternatively, the sensor chip 11 may be configured to detect a physical quantity other than acceleration and angular velocity.

The terminal 20 can act as an external connection terminal, through which the electronic component 10 is electrically connected to an external element (i.e., an element that is external with respect to the electronic component 10). The terminal 20 is multiple terminals each having a first end part 21 and a second end part 22. Each terminal 20 is formed through pressing or etching a terminal material. The sensor chip 11 and the capacitor 12 are mounted to and electrically connected to the first end part 21 of the terminal 20.

The insulating resin 30 electrically insulates the first end part 21 of the terminal 20 and the electronic component 10 from the case resin 40. As shown in FIG. 2, the insulating resin 30 seals the electronic component 10 and the first end part 21 of the terminal 20 so that the second end part 22 of the terminal 20 is exposed from the insulating resin 30. All of the first end part 21 of the terminal 20 is covered by the insulating resin 30. Thus, only the second end part 22 of the terminal 20 is exposed from the insulating resin 30. A material of the insulating resin 30 is, for example, epoxy resin.

The case resin 40 forms an outer shape of the sensor apparatus. Moreover, the case resin 40 acts as a shield against an electromagnetic noise entering an inside of the sensor apparatus from an outside of the sensor apparatus. For acting as the shield, the case resin 40 is mixed with electrically conductive filler 40a homogenously. As shown in FIG. 2, the case resin 40 seals the insulating resin 30 so as to surround the insulating resin 30, so that an edge portion of the second end part 22 is exposed from the case resin 40. More specifically, the case resin 40 seals the insulating resin so that a first portion of the second end part 22 is exposed from the case resin 40 and a second portion of the second end part 22 is covered by the case resin 40.

The conductive filler 40a may be made of metal, or may be glass filler coated with metal. A piece of the conductive filler 40a has, for example, a columnar shape with tens of micron meters. In FIG. 2, the conductive filler 40a is illustrated as if having a larger size than an actual size to be easily viewable, but the conductive filler 40a is actually tiny ones. Some pieces of the conductive filler 40a may contact with each other. A material of the case resin 40 may be PBT (poly butylene terephthalate), nylon, PPS (polyphenylene sulfide), or the like.

The case resin 40 has a waterproof connector 41 for external electric connection. The first portion of the second end part 22 of each terminal 20 is exposed to an inside of the waterproof connector 41. The waterproof connector 41 protects each terminal 20 from water and the like when the inside of the waterproof connector 41 is closed by a connecting cable.

A metal bush 60 for fixing the sensor apparatus to a body 70 of a vehicle is sealed in the case resin 40. The metal bush 60 is tubular and is sealed in the case resin 40 so that a vehicle side part of the metal bush 60 is protruded from a wall surface of the case resin 40. The vehicle side part of the metal bush 60 is a part that is to be brought into contact with the body 70 of the vehicle.

The coating material 50 electrically insulates the second portion of the second end part 22 of the terminal 20 from the case resin 40. Note that the second portion of the second end part 22 of the terminal 20 is covered by the case resin 40, and the first portion of the second end part 22 of the terminal 20 is exposed from the case resin 40. Since the case resin 40 is mixed with the conductive filler 40a, the coating material 50 functions to insulate the case resin 40 and each terminal 20 from each other. Moreover, the coating material 50 functions to insulate the multiple terminals 20 from each other.

The coating material 50 has a part exposed to the inside of the waterproof connector 41. Moreover, as shown in FIG. 2, the part of the coating material 50 is protruded from the wall surface of the case resin 40. Alternatively, the part of the coating material 50 may be exposed from the case resin 40 such that an exposure surface of the coating material 50, which is a surface exposed from the wall surface of the case resin 40, is made flush with the wall surface of the case resin 40. Rubber, resin or the like can be used as a material of the coating material 50.

A manufacturing method of the above sensor apparatus is illustrated below. The multiple terminals 20 are formed by pressing a terminal material or the like. The electronic component 10 including the sensor chip 11 and the capacitor 12 is prepared. The electronic component 10 is mounted to the first end part 21 of the terminal 20. Then, as a first molding process or a first shaping process, the electronic component 10 and the terminal 20 are sealed by the insulating resin 30 so that the second end part 22 of each terminal 20 is exposed from the insulating resin 30. Further, the coating material 50 is formed on a portion of the second end part 22 of the terminal 20, the portion being to be covered by the case resin 40.

Then, as a second molding process or a second shaping process, the insulating resin 30 and the coating material 50 are sealed by the case resin 40 mixed with the conductive filler 40a so that the case resin 40 surrounds the insulating resin 30 and the coating material 50. In the second molding process or the second shaping process, the metal bush 60 is formed in the case resin 40 by insert molding, and the first portion of the second end part 22 of each terminal 20 is positioned inside the waterproof connector 41. In the above, the part of the coating material 50 is exposed to the inside of the waterproof connector 41. Through the above processes, the sensor apparatus illustrated in FIGS. 1 and 2 can be manufactured.

According to the sensor apparatus having the above-described structure, since the case resin 40 is mixed with the electric conduction filler 40a, the inside of the case resin 40 is electrically shielded from the outside of the case resin 40. That is, since the case resin 40 is wrapped around the electronic components 10, the electromagnetism noise cannot enter the inside of the case resin 40 even when the electromagnetic noise is applied to the sensor apparatus from the outside of sensor apparatus. The electronic component 10 is electrically shielded by the case resin 40 mixed with the electric conduction filler 40a. Therefore, it is possible to minimize an influence of electromagnetic noise S on the electronic component 10 and prevent the electromagnetic noise from causing an error of the electronic component 10. A noise resistance performance of the sensor apparatus is improved.

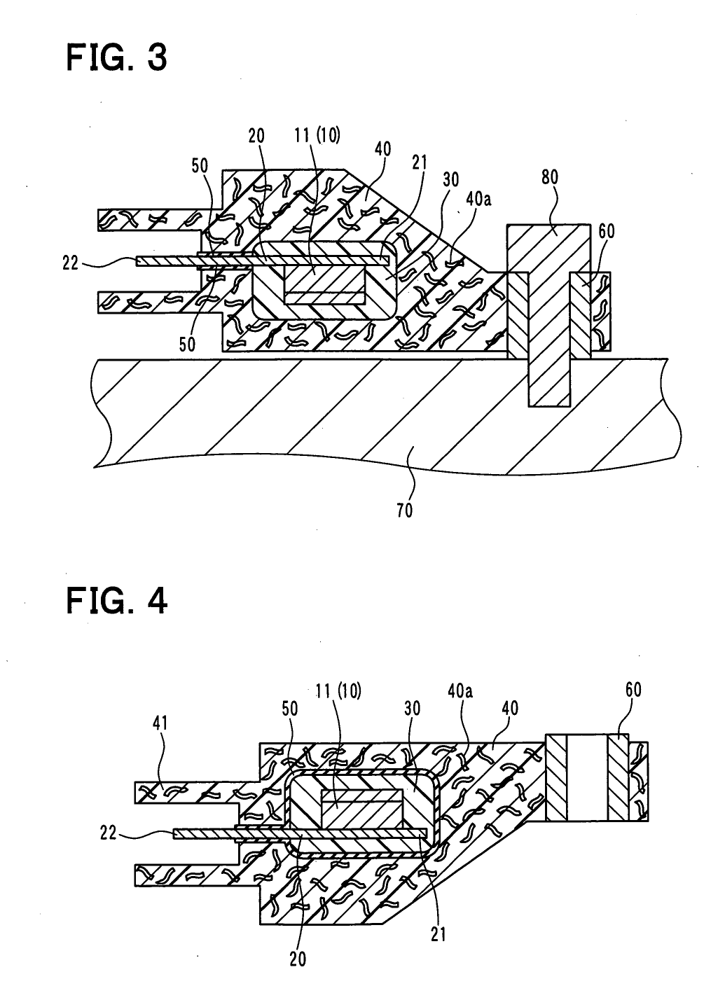

A structure for attaching the above sensor apparatus to the body 70 of the vehicle is illustrated below with reference to FIG. 3. FIG. 3 is a diagram illustrating a cross sectional view of the sensor apparatus that is attached to the body 70 of the vehicle. The body 70 is a frame of the vehicle and is made of metal. The sensor apparatus can be mounted to various parts of the body 70 of the vehicle, including an engine room and an inside of a pillar.

More specifically, the sensor apparatus is fixed to the body 70 by bringing the metal bush 70 into contact with the body 70, and inserting a metal bolt into the metal bush 70 for screw lock. As described above, since the metal bush 60 is protruded from the wall surface of the case resin 40, only the metal bush 60 contacts the body 70 among parts of the sensor apparatus. Through the above manners, the sensor apparatus is attached to the body 70.

According to the above attachment structure, the case resin 40 mixed with the electric conduction filler 40a is electrically connected to the body 70 via the metal bush 60 and the metal bolt 80. The electromagnetic noise entering the case resin 40 flows into the body 70 via the electric conduction filler 40a, the metal bush 60 and the metal bolt 80. It is possible to transfer the electromagnetic noise to the body 70. Thus, it becomes possible to readily remove the electromagnetic noise by connecting the sensor apparatus to the body 70 to ground the sensor apparatus. It is possible to enhance an electromagnetic shield performance of the case resin 40.

In the above structure, since the conductive filler 40a in the case resin 40 acts as a shield against the electromagnetic noise, the electronic component 10 can be electrically-shielded. Therefore, even when a sensor apparatus is configured not to have a printed circuit board, it is possible to improve a noise resistance of the sensor apparatus and it is possible to prevent the sensor apparatus having an error caused by an electromagnetic noise when the sensor apparatus is placed in an electromagnetic noise condition.

Moreover, according to the attachment structure of the sensor apparatus, since the metal bush 60 is sealed in the case resin 40 and the sensor apparatus is fixed to the body 70 via the metal bolt 80, it is possible to transfer the electromagnetic noise to the body 70. Therefore, the use of the attachment structure can improve the electromagnetic shield performance and the noise resistance of the sensor apparatus.

Moreover, since the case resin 40 has the waterproof-connector 41, and since the coating material 50 and the terminal 20 are exposed to the inside of the waterproof connector 41, it is possible to prevent the terminal 20 and the coating material 50 from contacting water and the like. It is therefore improve waterproofing in the inside of the case resin 40.

In the above, the body 70 of the vehicle is an example of a target object for attachment.

### Second Embodiment

A second embodiment is illustrated below through describing a difference between the first and second embodiments. FIG. 4 illustrates a cross sectional view of a sensor apparatus according to the present embodiment. FIG. 4 corresponds to FIG. 2 in that the cross sectional view corresponds one taken along line I in FIG. 1.

As shown in FIG. 4, in the present embodiment, the coating material 50 is formed not only on the second portion of the second end part 22 of the terminal 20 but also on a wall surface of the insulating resin 30. It should be noted that: the second end part 22 is a part exposed from the insulating resin 30; the first portion of the second end part 22 is a portion exposed from the case resin 40; and the second portion of the second end part 22 is a portion covered by the case resin 40. In the present embodiment, the coating material 50 is provided on all of covered portions of the terminal 20 and the insulating resin 30, the covered portions being covered by the case resin 40.

The case resin 40 is formed on the coating material 50. In other words, the case resin 40 seals the coating material 50 so as to surround the coating material 50. The coating material 50 electrically insulates the second portion of the terminal 20 and the insulating resin 30 from the case resin 40.

In the above structure, since the coating material 50 can be provided on all of the second end part 22 of the terminal 20 and the insulating resin 30 except the first portion (i.e., an edge portion) of the second end part 22 of the terminal 20, it is possible to perform a process of forming the coating material 50 easily, compared to a case where the coating material 50 is provided on only the second portion of the second end part 22 of the terminal 20. The sensor apparatus of the present embodiment can have the same attachment structure as that illustrated in FIG. 3.

### Third Embodiment

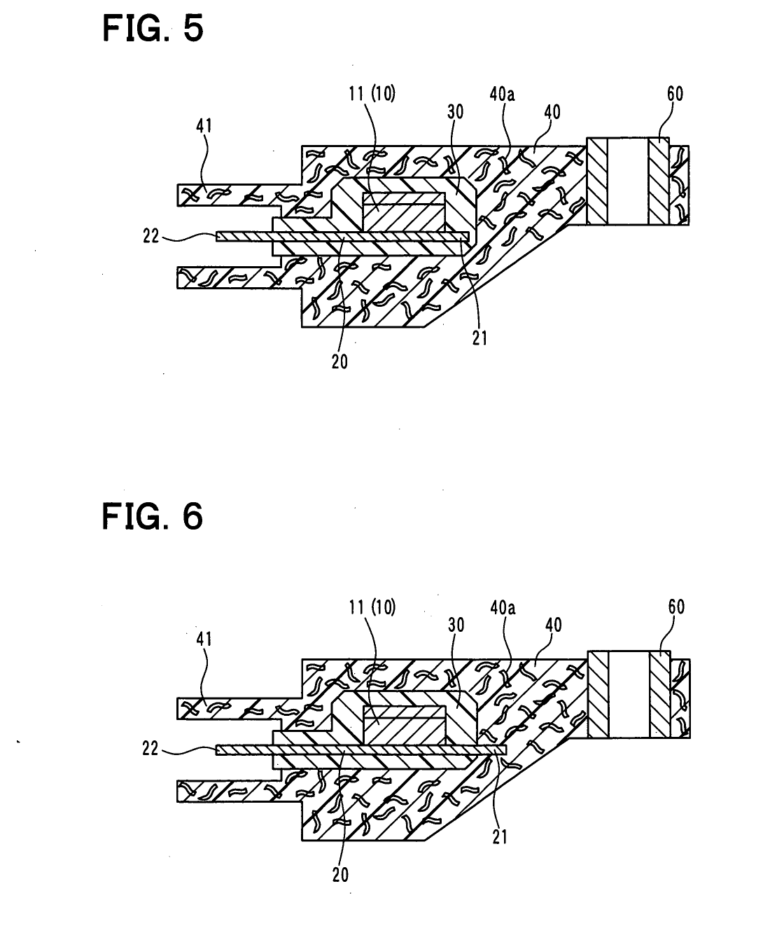

A third embodiment is illustrated below through describing a difference between the first and third embodiments. FIG. 5 illustrates a cross sectional view of a sensor apparatus according to the present embodiment. FIG. 5 corresponds to FIG. 2 in that the cross sectional view corresponds one taken along line II-II in FIG. 1.

As shown in FIG. 5, the present embodiment does not use the coating material 50. The present embodiment uses the insulating resin 30 as a substitute for the coating material 50 to electrically insulate the terminal 20 from the case resin 40.

In the present embodiment, the insulating resin 30 is further provided between the multiple terminals 20, thereby ensuring that the terminals 20 are insulated from each other.

More specifically, the case resin 40 seals the insulating resin 30 so as to surround the insulating resin 30, such that a predetermined part of the insulating resin 30 is exposed and protruded from the wall surface of the case resin 40. In the above, the predetermined part of the insulating resin 30 is a part from which the second end part 22 of the terminal 20 is exposed. In the above structure, the insulating resin 30 is protruded from the wall surface of the case resin 40 into the inside of the waterproof connector 41. The second end part 22 of the terminal 20 is exposed to the inside of the waterproof connector 41.

According to the above structure, since the terminal 20 does not contact the case resin 40, it is possible to prevent an occurrence of short between the case resin 40 and the terminal 20 sealed by the insulating resin 30. The sensor apparatus of the present embodiment can have the same attachment structure as that illustrated in FIG. 3.

### Fourth Embodiment

A fourth embodiment is illustrated below through describing a difference between the third and fourth embodiments. FIG. 6 illustrates a cross sectional view of a sensor apparatus according to the present embodiment. FIG. 6 corresponds to FIG. 3 in that the cross sectional view corresponds one taken along line II-II in FIG. 1.

In the present embodiment, as shown in FIG. 6, the terminals 20 has a GND terminal 20, an edge portion of the first end part 21 of which is protruded from the insulating resin 30. The protruded edge portion of the first end part 21 of the GND terminal 20 is sealed by the case resin 40. Accordingly, the protruded edge portion of the first end part 21 of the GND terminal 20 is in direct contact with the case resin 40. The GND terminal 20 can be connected to an external GND (e.g., the body 70 of the vehicle).

According to the above structure, since the conductive filler 40a is connected to the GND via the GND terminal 20, the electromagnetic noise flows into the GND. It is therefore possible to improve an electromagnetic shield performance of the case resin 40.

The sensor apparatus of the present embodiment can be fixed to the body 70 of, the vehicle by bringing the metal bush 60 into contact with the body 70 and inserting and screwing the metal bolt 80 in the metal bush 60, in a manner similar to the attachment structure illustrated in FIG. 3.

### Fifth Embodiment

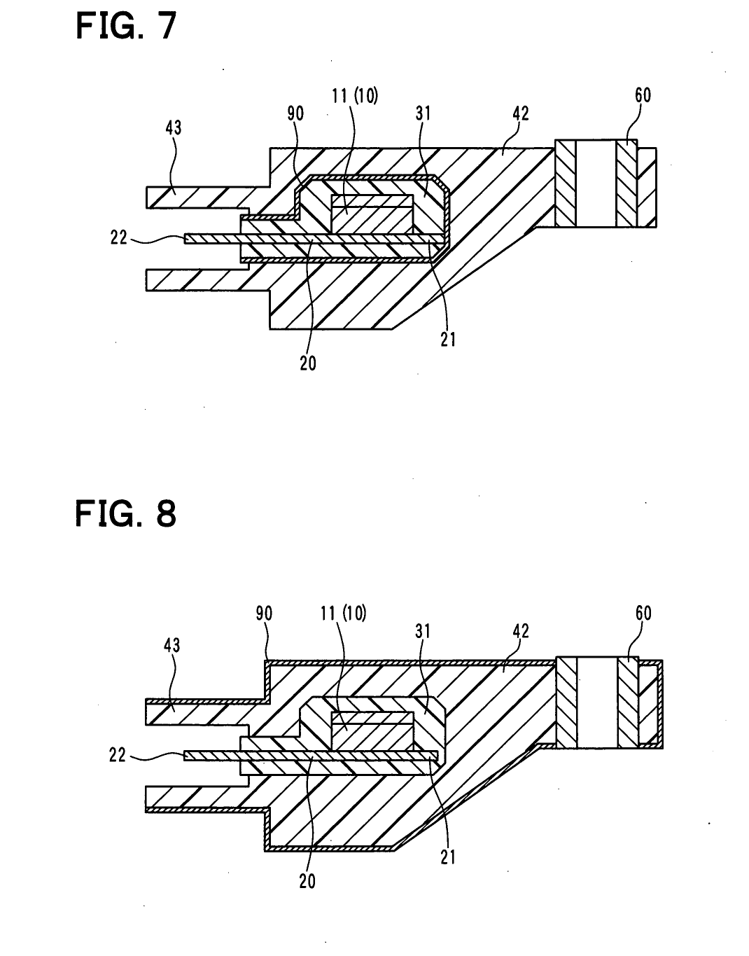

A fifth embodiment is illustrated below with reference to FIG. 7. The present embodiment is different from the first to fourth embodiments in the following point. In the first to fourth embodiments, the case resin 40 mixed with the conductive filler 40a is used to provide an electromagnetic shield; while in the present embodiment, a conductive film is used to provide an electromagnetic shield.

FIG. 7 illustrates a cross sectional view of a sensor apparatus according to the present embodiment. FIG. 7 corresponds to FIG. 2 in the cross sectional view in that the cross sectional view corresponds one taken along line II-II in FIG. 1. The sensor apparatus of the present embodiment includes an electronic component 10, multiple terminals 20, a first insulating resin 31, a conductive film 90 and a second insulating resin 42.

Among the above components of the sensor apparatus, the electronic component 10 and the terminal 20 can be the same ones as those illustrated in the first to fourth embodiments.

The first insulating resin 31 can be the same as the insulating resin 30 illustrated in the above embodiments. The first insulating resin 31 seals the electronic component 10 and the first end part 21 of the terminal 20 so that the second end part 22 of the terminal 20 is exposed from the first insulating resin 30. Further, the first insulating resin 31 seals each terminal 20, such that, among the multiple terminals 20, an edge portion of the first end part 21 of the GND terminal 20 is exposed from the first insulating resin 31. The multiple terminals 20 are electrically insulated from each other by the first insulating resin 30. The first insulating resin 31 is made of, for example, epoxy resin.

The conductive film 90 is formed on a wall surface of the first insulating resin 31 so as to surround the first insulating resin 31. Moreover, the conductive film 90 acts as a shield against electromagnetic noise entering an inside of the sensor apparatus from an outside of the sensor apparatus. In the present embodiment, the conductive film 90 covers the first insulating resin 31 except the predetermined part of the first insulating resin 30 from which the second end part 22 of terminal 20 is exposed. Because of this structure, the short between the conductive film 90 and the terminal 20 is prevented.

As illustrated in the above, since the edge portion of the first end part 21 of the GND terminal 20 is exposed from the first insulating resin 31, the GND terminal 20 directly contacts the conductive film 90 because the conductive film 90 is formed on the wall surface of the first insulating resin 31.

A material of the conductive film 90 is, for example, Sn, Au, Cu or the like. The conductive film 90 is formed on the wall surface of the first insulating resin 31 by, for example, plating.

The second insulating resin 42 seals the conductive film 90 so that the second end part 22 of the terminal 20 is exposed from the first and second insulating resins 31, 42. The second insulating resin 42 has a waterproof connector 43 for external connection to an external apparatus, and further seals the metal bush 60 for attaching the sensor apparatus to the body of the vehicle. This structure improves a waterproof performance in the inside of the second insulating resin 42. A material of the second insulating resin 42 is, for example, PBT (poly butylene terephthalate), nylon, PPS (polyphenylene sulfide), or the like.

A predetermined part of the first insulating resin 30 and a predetermined part of the conductive film 90 are protruded from the wall surface of the second insulating resin 42 into the inside of the waterproof connector 43. In the above, the predetermined part of the first insulating resin 30 is a part from which the second end part 22 of the terminal 20 is exposed, and the predetermined part of the conductive film 90 surrounds the predetermined part of the first insulating resin 30 so as not to contact the terminal 20. The second end part 22 of the terminal 20 is exposed to the inside of the waterproof connector 43.

The sensor apparatus having the above structure can be fixed to the body 70 by inserting and screwing the metal bolt 80 to the metal bush 60 in a manner similar to that illustrated in FIG. 3.

According to the above structure, since the conductive film 90 surrounds the electronic component 10, the conductive film 90 shields the electronic component 10 against the electromagnetic noise. It is possible to prevent an electromagnetic noise from entering the inside of the first insulating resin 31. Electromagnetic shielding of the electronic components 10 is realized.

Moreover, since the GND terminal 20 directly contacts the conductive film 90, the conductive film 90 can be electrically connected to GND (e.g., the body 70 of the vehicle). The electromagnetism noise received by the conducting film 90 can be transferred to GND, and the electromagnetic shielding performance can be enhanced.

### Sixth Embodiment

A sixth embodiment is illustrated below through describing a difference between the fifth embodiment and the present embodiment. In the fifth embodiment, the conductive film 90 is formed on the wall surface of the first insulating resin, 31; in the present embodiment, a conductive film 90 is formed on a wall surface of the second insulating resin 42.

FIG. 8 illustrates a cross sectional view of a sensor apparatus according to the present embodiment. FIG. 8 corresponds to FIG. 2 in that the cross sectional view corresponds to one taken along line in FIG. 1. As shown in FIG. 8, the first insulating resin 31 seals the electronic component 10 and the first end part 21 of the terminal 20 so that the second end part 22 of the terminal 20 is exposed from the first insulating resin 31. The second insulating resin 42 seals the first insulating resin 31 so that the second end part 22 of the terminal 20 is exposed from the first and second insulating resins 31, 42.

The second insulating resin 42 has a waterproof connector 43 for external connection to an external apparatus. The second end part 22 of the terminal 20 is exposed to the inside of the waterproof connector 43. This structure improves a waterproof performance at the inside of the second insulating resin 42.

A predetermined part of the first insulating resin 31 is protruded from the wall surface of the second insulating resin 42 into the inside of the waterproof connector 43. In the above, the predetermined part of the first insulating resin 31 is a part from which the second end part 22 of the terminal is exposed. The metal bush 60 is sealed in the second insulating resin 42.

The conductive film 90 is formed on the wall surface of the second insulating resin 42 so as to surround the second insulating resin 42. This conductive film 90 formed on the wall surface of the second insulating resin 42 contacts the metal bush 60.

The sensor apparatus having the above structure can be fixed to the body 70 by bringing the metal bush 60 into contact with the body 70 of the vehicle, and inserting and screwing the metal bolt 80 into the metal bush 60 in a manner similar to that illustrated in FIG. 3. Thereby, the conductive film 90 is grounded (i.e., connected to the body 70) via the metal bush 60 and the metal bolt 80.

According to the above structure, the electronic component 10 is surrounded by the conductive film 90. The conductive film 90 thus acts as a shield against electromagnetic noise, and the electronic component 10 can be electro-magnetically shielded.

Moreover, since the conductive film 90 can be electrically connected to the body 70 of the vehicle via the metal bush 70 and the metal bolt 80, it is possible to transfer the electromagnetic noise to the body 70 of the vehicle. It is therefore possible to enhance an electromagnetic shield performance of the conductive film 90.

### Other Embodiments

The above-described embodiment can be modified in various ways, examples of which are described below.

In the above embodiments, the electronic component 10 includes a sensor chip 11 and a capacitor 12. Alternatively, the electronic component 10 may include another element or part.

In the above embodiments, the body 70 of the vehicle is illustrated as a target object for sensor apparatus attachment. Alternatively, the target object may be another object and not be limited to the body 70 of the vehicle.

Although the case resin 40 or the second insulating resin 42 has the waterproof connector 41, 43 in the above embodiments, this is merely an exemplary shape of the case resin 40 or the second insulating resin 42. The case resin 40 or the second insulating resin 42 may not have the waterproof connector 41, 43.

Although in the above embodiments the metal bush 60 is sealed in the case resin 40 or the second insulating resin 42 so as to project from the wall surface of the case resin 40 or the second insulating resin 42, this structure is merely an illustrative example. For example, the metal bush 60 may be sealed so as not to project from the wall surface of the case resin 40 or the second insulating resin 42.

For example, the metal bush 60 may be sealed so that an exposure surface of the metal bush 60 is flush with the wall surface of the case resin 40 or the second insulating resin 42. When this structure is employed in the first to fourth embodiments, the metal bush 60 and the case resin 40 can contact the body 70 of the vehicle. When the structure is employed in the fifth embodiment, the metal bush 60 and the second insulating resin 42 can contact the body 70 of the vehicle. When the structure is employed in the six embodiments, the metal bush 60 and the conductive film 90 can contact the body 70 of the vehicle. According to these structures, since it is possible to increase a contact area of a metal material that is brought into contact with the body 70 of the vehicle, it is possible to more efficiently transfer the electromagnetic noise to the body 70 and it is possible to enhance an electromagnetic shield performance.

In the fifth embodiment, the edge portion of the first end part 21 of the GND terminal 20 is exposed from the first insulating resin 31 and directly contacts the conductive film 90. Alternatively, the second end part 22 of the GND terminal 20, which is exposed from the first insulating resin 31, may directly contact the conductive film 90.

While the invention has been described above with reference to various embodiments thereof, it is to be understood that the invention is not limited to the above described embodiments and constructions. The invention is intended to cover various modifications and equivalent arrangements. In addition, while the various combinations and configurations described above are contemplated as embodying the invention, other combinations and configurations, including more, less or only a single element, are also contemplated as being within the scope of embodiments.

What is claimed is:

1. A sensor apparatus comprising:
an electronic component that is configured to detect a physical quantity and output an electric signal indicative of the detected physical quantity;
a terminal that has a first end part and a second end part, the first end part being electrically connected with the electronic component;
an insulating resin that seals the electronic component and the first end part of the terminal so that the second end part of the terminal is exposed from the insulating resin;
a case resin that is mixed with a conductive filler, and seals the insulating resin so as to surround the insulating resin so that a first portion of the second end part is exposed from the case resin and a second portion of the second end part is covered by the case resin; and
a coating material that is formed on the second portion of the second end part of the terminal to electrically insulate the terminal from the case resin.

2. The sensor apparatus according to claim 1, wherein:
the coating material is further formed on a wall surface of the insulating resin; and
the case resin seals the coating material so as to surround the coating material, so that the first portion of the second end part of the terminal is exposed from the case resin.

3. The sensor apparatus according to claim, wherein:
the case resin has a waterproof connector for external electrical connection;
the first portion of the second end part of the terminal is exposed to an inside of the waterproof connector; and
the coating material has a part that is exposed to the inside of the waterproof connector from a wall surface of the case resin.

4. A sensor apparatus comprising:
an electronic component that is configured to detect a physical quantity and output an electric signal indicative of the detected physical quantity;
a terminal that has a first end part and a second end part, the first end part being electrically connected with the electronic component;
an insulating resin that seals the electronic component and the first end part of the terminal so that the second end part of the terminal is exposed from a predetermined part of the insulating resin; and
a case resin that is mixed with a conductive filler, and seals the insulating resin while surrounding the insulating resin so that
the predetermined part of the insulating resin is protruded from a wall surface of the case resin, and
the second end part of the terminal is exposed from the predetermined part of the insulating resin.

5. The sensor apparatus according to claim 4, wherein:
the case resin has a waterproof connector for external electrical connection;
the predetermined part of the insulating resin is protruded from the wall surface of the case resin into the inside of the waterproof connector; and
the second end part of the terminal is exposed to the inside of the waterproof connector.

6. The sensor apparatus according to claim 4, wherein:
the terminal is a plurality of terminals, one of which is a GND terminal; and
an edge portion of the first end part of the GND terminal is protruded from the insulating resin and is sealed by the case resin, so that the protruded edge portion of the first end part of the GND terminal directly contacts the case resin.

7. A sensor apparatus comprising:
an electronic component that is configured to detect a physical quantity and output an electric signal indicative of the detected physical quantity;
a terminal that has a first end part and a second end part, the first end part being electrically connected with the electronic component;
a first insulating resin that seals the electronic component and the first end part of the terminal so that the second end part of the terminal is exposed from a predetermined part of the first insulating resin; and
a conductive film that is formed on a wall surface of the first insulating resin so as to surround the first insulating resin; and
a second insulating resin that seals the conductive film so that
the predetermined part of the first insulating resin is protruded from a wall surface of the second insulating resin, and
the second end part of the terminal is exposed from the predetermined part of the first insulating resin,
wherein the terminal is a plurality of terminals, one of which is a GND terminal directly contacting the conductive film.

8. A sensor apparatus comprising:
an electronic component that is configured to detect a physical quantity and output an electric signal indicative of the detected physical quantity;
a terminal that has a first end part and a second end part, the first end part being electrically connected with the electronic component;
a first insulating resin that seals the electronic component and the first end part of the terminal so that the second end part of the terminal is exposed from a predetermined part of the first insulating resin;
a second insulating resin that seals the first insulating resin so that the second end part of the terminal is exposed; and
a conductive film that is formed on a wall surface of the second insulating resin so as to surround the second insulating resin,
wherein the predetermined part of the first insulating resin is protruded from the second insulating resin.

9. The sensor apparatus according to claim 7, wherein:
the second insulating resin a waterproof connector for external electrical connection;
the second end part of the terminal is exposed to an inside of the waterproof connector; and
the predetermined part of the first insulating resin is protruded from the wall surface of the second insulating resin into the inside of the waterproof connector.

10. A structure for sensor apparatus attachment to a target object, the structure comprising:
a sensor apparatus recited in claim 1; and
a tubular metal bush that is sealed in the case resin and is configured to fix the sensor apparatus to the target object in such manner that the tubular metal bush is brought into contact with the target object, and a metal bolt is inserted into the tubular metal bush.

11. A structure for sensor apparatus attachment to a target object, the structure comprising:
a sensor apparatus recited in claim 7; and
a tubular metal bush that is sealed in the second insulating resin and is configured to fix the sensor apparatus to the target object in such manner that the tubular metal bush is brought into contact with the target object, and a metal bolt is inserted into the tubular metal bush.

12. A structure for sensor apparatus attachment to a target object, the structure comprising:
a sensor apparatus recited in claim 8; and
a tubular metal bush that is sealed in the second insulating resin and is configure to fix the sensor apparatus to the target object in such manner that the tubular metal bush is brought into contact with the target object, and a metal bolt is inserted into the tubular metal bush,
wherein the conductive film is formed on the wall surface of the second insulating resin so that the tubular metal bush contacts the conductive film.
